(19) United States
(12) Patent Application Publication
(10) Pub. No.: US 2024/0251816 A1
(43) Pub. Date: Aug. 1, 2024

(54) Composition in the Form of a Supramolecular Arrangement Including Hydrophilic Molecules Which is Stabilized by Mineral Particles in a Lipid Phase

(71) Applicant: HUDDLE CORP, SAINT HERBLAIN (FR)

(72) Inventors: Abdeslam EL HARRAK, FAULQUEMONT (FR); Clara JIMENEZ SAELICES, NANTES (FR); Célia MOUSTIES, SAINT REMY DE PROVENCE (FR); César, Adrien, Claude, René CRETEL, NANTES (FR)

(21) Appl. No.: 18/289,699

(22) PCT Filed: May 12, 2022
(86) PCT No.: PCT/FR2022/050908

§ 371 Date: Dec. 4, 2023

(30) Foreign Application Priority Data
May 12, 2021 (FR) FR2105038

(51) Int. Cl. A23D 9/007; A23D 7/005; A23D 7/04; A23D 9/04; A23K 20/158; A23K 20/28; A23K 40/25; A23K 40/30; A23K 50/75; A23K 50/80; C11B 5/00

(52) U.S. Cl. CPC A23D 9/007; A23D 7/005; A23D 7/04; A23D 9/04; A23K 20/158; A23K 20/28; A23K 40/25; A23K 40/30; A23K 50/75; A23K 50/80; C11B 5/0021; C11B 5/0028; C11B 5/0035; C11B 5/0085

(57) ABSTRACT

Lipid composition comprising unsaturated lipids such as omega 3 and omega 6, antioxidants and phyllosilicate particles, wherein the phyllosilicate particles are clusters of sheets, wherein said antioxidants comprise water-soluble antioxidants dissolved in the water adsorbed in the phyllosilicate sheets and wherein the phyllosilicate sheets are dispersed in the composition by an amphiphilic dispersant adsorbed on the surface of the phyllosilicate particles.

### FIELD OF THE INVENTION

The present invention relates to compositions comprising unsaturated lipids such as omega 3 and omega 6. It relates, in particular, to a composition for which the resistance to oxidation is reinforced, for direct use or as an ingredient in formulations requiring lipids that are more stable to oxidation during the transformation process or during storage.

### PRIOR ART

Lipids constitute the fatty matter of living beings. These are very diversified hydrophobic or amphiphilic molecules—hydrophobic molecules having a hydrophilic region—that can be saturated or unsaturated, comprising among others, fats, waxes, sterols, liposoluble vitamins, mono-, di- and triglycerides, or even phospholipids.

They play a role in both energy storage, as the main constituent of the membranes of the cells of living beings, and in communication between cells by lipid signalling mechanisms, and thus constitute a very important part of human and animal nutrition.

Unsaturated lipids are molecules sensitive to oxidation. The main factors are temperature, oxygen and light. Lipid oxidation can be initiated by reaction between reactive species of oxygen and an unsaturated fatty acid. This oxidation mechanism is then followed by a propagation and termination step.

FIG. 1 schematically illustrates the oxidation mechanism of an unsaturated fatty acid.

The first step which activates the lipids (LH) leads to a lipid radical L·:

LH+OH·→H2O+L

The lipid free radicals react with oxygen in order to generate peroxyl radicals:

L·+O2→LOO·

In the propagation phrase, the peroxyl radicals, in turn react with other unsaturated fatty acids to form hydroperoxides and a new reactive lipid radical:

LOO·+L′H→LOOH+L′

Then, in the termination phase, the hydroperoxides decompose via a radical pathway or a non-radical pathway. The majority of secondary compounds formed are aldehydes, carbonyls, alcohol and hydrocarbons.

These secondary compounds include malondialdehyde (MDA) which is a marker for the oxidation of polyunsaturated lipids containing more than two double bonds. Once the oxidation mechanism is initiated, and following the formation of hydroperoxide, the latter will potentially decompose into MDA and 4-hydroxy-2-nonenal (4-HNE).

Lipid oxidation can therefore be monitored by assaying hydroperoxides.

It has been shown that the oxidation of lipids, and in particular of unsaturated fatty acids such as omega 3 and omega 6, can cause irreversible damage from a metabolic point of view.

In food matrices, there are two possibilities for introducing lipids. The first is to place them inside the matrix in order to limit the access of UV radiation and oxygen. The second possibility is to place them on the outside as a coating when the manufacturing process of the food involves high temperatures, in order to limit the consequences of the high temperatures at which the lipids are used.

Despite everything, in these two cases the lipids are exposed to potential oxidation either during the process or during storage. High temperatures are often used in food formulation processes, in particular in the manufacture of foods as pellets by extrusion. Furthermore, storage conditions that make it possible to improve the stability over time of sensitive nutriments, such as modified atmosphere conditions during packaging (packaging under vacuum or under a non-oxidising atmosphere), are used only rarely or not at all, and the products are therefore exposed to oxygen.

There is therefore a growing need for systems which can protect and delay the oxidation of lipids, while simplifying the use of lipid fractions in foods, whether inside or outside the food matrices.

### BRIEF DESCRIPTION OF THE INVENTION

The aim of the invention is to provide a lipid composition comprising a system that can protect and delay the oxidation of unsaturated lipids, either inside or outside the food matrices.

The object of the invention is a lipid composition comprising unsaturated lipids such as omega 3 and omega 6, antioxidants, an amphiphilic dispersant and phyllosilicate particles, characterised in that the phyllosilicate particles are clusters of sheets in which water is absorbed, in that said antioxidants comprise water-soluble antioxidants dissolved in said water adsorbed in said phyllosilicate sheets with an antioxidant content greater than 0.01 wt % relative to the weight of lipids of the composition, and in that the phyllosilicate sheets are dispersed and exfoliated in the composition by said amphiphilic dispersant adsorbed on the surface of the phyllosilicate sheets.

In other words, the invention relates to a lipid composition comprising a lipid phase comprising unsaturated lipids such as omega 3 and omega 6, an amphiphilic dispersant and phyllosilicate particles dispersed and exfoliated in said lipid phase, characterised in that the phyllosilicates are in the form of sheets in which water and water-soluble antioxidants are adsorbed.

In other words, the lipid composition comprises no water other than the water absorbed in the phyllosilicate sheets.

In other words, the composition comprises exfoliated phyllosilicates, i.e. phyllosilicates for which the sheets have been separated by exfoliation.

In the context of the present invention, the term “exfoliated” means phyllosilicates having undergone an exfoliation, i.e. a more or less complete separation of its individual sheets.

The exfoliation process usually comprises three phases:
(1) swelling of the phyllosilicate sheets by water,
(2) absorbing a hydrophobic molecule at the surface of the phyllosilicate particles, in order to make it compatible with the dispersion lipid phase, for example lecithin, and
(3) applying shear energy in order to separate the phyllosilicate particles in the lipid phase.

The phyllosilicates thus act as a vehicle for water-soluble antioxidants which can thus be homogeneously dispersed in the lipid phase.

In the context of the invention, the terms “clays” or “mineral particles” are used interchangeably to designate and describe the phyllosilicates.

The water-soluble antioxidants of the composition dissolved in the water for swelling and exfoliation of phyllosilicates are dispersed and stabilised in the lipid phase by the phyllosilicate particles. The dispersant or amphiphilic surface can make the outer surface of the clusters of sheets partially hydrophobic, and thus enables the dispersion and stabilisation of these clusters of sheets in the lipid phase. The dispersion of water-soluble antioxidant molecules is thus obtained by the clusters of phyllosilicate sheets, by the water absorbed in the sheets and by the dispersant or surfactant absorbed at the surface of the sheets, which together constitute a supramolecular structure. The minimum content of water-soluble antioxidants indicated is that below which their effectiveness becomes insufficient. This content corresponds substantially to an equivalent of water-soluble vitamin relative to vitamin E that is naturally present in oils.

Advantageously, the content of water-soluble antioxidant is between 0.125 wt % and 50 wt % relative to the weight of phyllosilicate particles, and preferably between 0.375 wt % and 35 wt % relative to the weight of phyllosilicate particles.

Beyond this value of 50%, it becomes difficult to dissolve them in the swelling water of the phyllosilicates. Indeed, the phyllosilicates are swelled by water promoting their exfoliation, but also constituting the solubilisation medium of the water-soluble antioxidants.

The water thus present in the phyllosilicates advantageously represents up to 200% of the weight of phyllosilicates of the lipid phase (described below). Vitamin C, which is a water-soluble antioxidant effective in protecting lipids, has a solubility constant in water of 330 mg/ml, and cannot represent more than 66% of the weight of the phyllosilicates. Taking into account the (unavailable) water absorbed on the surface, it is preferable to limit the quantity of vitamin C to 50% of the weight of phyllosilicates, i.e. 25 mg/ml.

The water-soluble antioxidant can be chosen from the group consisting of reducing salts, reducing enzymes, flavonoids, phenolic derivatives, water-soluble vitamins and combinations thereof. Preferably, the antioxidant of the composition is vitamin C.

Advantageously, the amphiphilic dispersant is chosen from the group consisting of ethyl lauroyl arginate (LAE), arginine-based cationic surfactants with 16 and more carbon atoms, phospholipids and combinations thereof.

Preferably, the dispersant or amphiphilic surface is a phosphoglyceride and very preferably a phosphatidylcholine and extremely preferably lecithin.

Advantageously, the phyllosilicate sheets are smectite sheets and very preferably mostly montmorillonite sheets.

Preferably, the content of dispersant or surfactant of the composition is between 10 wt % and 400 wt % and very preferably between 20 wt % and 200 wt %, relative to the weight of phyllosilicates.

Preferably, the water content of the lipid composition is between 10 wt % and 300 wt % and very preferably between 20 wt % and 200 wt %, relative to the weight of phyllosilicates.

Preferably, the lipid composition comprises no water other than the water absorbed in the phyllosilicate sheets.

Preferably, the content of phyllosilicates in the lipid composition ranges from 0.005 to 20 wt %.

Preferably, the content of phyllosilicates in the lipid composition ranges from 0.5 to 20 wt %, preferably 1 to 20 wt %.

Preferably, the content of phyllosilicates in the lipid composition ranges from 0.005 to 5 wt %, preferably 0.005 to 2 wt %.

More advantageously, the content of phyllosilicates in the lipid composition ranges from 0.5 and 35 wt % and preferably 0.5 to 15 wt %, relative to the weight of the lipid composition.

Another object of the invention is an emulsion with an aqueous phase and a lipid phase, wherein the lipid phase corresponds to the lipid composition as previously described.

In this composition in the form of an emulsion, the phyllosilicate particles have a double role: ensuring the support and fine dispersion of the water-soluble antioxidants in the lipid phase, but also the role of mineral emulsifying particles which can equally be used for stabilisation of direct emulsions (O/W) or inverse emulsions (W/O), as well as double emulsions (W/O/W).

According to one embodiment, the emulsion is a direct emulsion and the overall phyllosilicate content, i.e. the weight of phyllosilicates, in the lipid phase is greater than 0.5 wt % relative to the weight of said lipid phase, and preferably between 1 wt % and 20 wt %.

In this embodiment, the viscosity of the lipid phase increases with, in particular, the phyllosilicate content and this is favourable for the obtaining a direct emulsion.

According to another embodiment, the emulsion is an inverse emulsion, and the overall phyllosilicate content in said lipid phase is less than 5 wt % relative to the weight of said lipid phase, and preferably between 0.005 wt % and 2 wt %.

In this embodiment, the viscosity of the lipid phase decreases with the decrease in the phyllosilicate content and this is favourable for obtaining an inverse emulsion.

Another object of the invention is foods, premix or food supplements in the form of modular stackable objects enabling protection against oxidation and a controlled release of nutritive and/or physiologically active substances for monogastric species, with an aqueous phase and a lipid phase with liposoluble active components, characterised in that the aqueous phase and the lipid phase form an emulsion as described above.

According to a first embodiment, the foods, premix or food supplements, are such that the emulsion is a direct emulsion and such that the droplets of the lipid phase, or dispersed lipid particles, have a biopolymer coating, preferably chosen from the group consisting of chitosan, polylysine, and hyaluronic acid.

According to a second embodiment, the foods, premix or food supplements comprise a core and a coating of the core and are such that the core comprises the aqueous phase and the lipid phase, and such that the aqueous phase includes water-soluble active substances.

In this embodiment, the aqueous phase can be dispersed in the continuous lipid phase.

The lipid phase can also be dispersed in the continuous aqueous phase. In this latter case, the aqueous phase is advantageously gelled.

The lipid composition as described above can advantageously also be incorporated or impregnated in an extruded food.

Another object of the invention is the use of phyllosilicates as lipid emulsion stabilisers.

These lipid emulsions comprise an aqueous phase and a lipid phase, and the phyllosilicate particles introduced and dispersed in the lipid phase can stabilise these diverse and inverse emulsions.

The above elements or products have the advantage of including, dispersed in the lipid phase, hydrophilic antioxidants, dispersed and stabilised by phyllosilicate particles. These antioxidants can reduce the harmful effects of the oxidation of unsaturated lipids. The antioxidants are indeed attacked more rapidly by reactive oxygen species, while remaining stable once oxidised, which allows the lipids not to be affected, or to delay the onset of this oxidation. The excess antioxidants not consumed in the protective mechanism constitute interesting nutritional contributions, with a delayed release in the digestive tract. This is an additional benefit to the proposed model of lipid stability used here.

The invention also relates to a method for dispersion and exfoliation of phyllosilicates in a lipid phase.

The method comprises the following steps:
a) Preparing an aqueous solution of one or more water soluble antioxidants.
b) Adding the amphiphilic dispersant
c) Stirring to obtain a homogeneous mixture
d) Adding the clay and stirring the mixture obtained
e) Adding a lipid phase and applying a shear energy.

In some embodiments, the mixture is left to rest after step d) then stirred again.

In some embodiments, the mixture is left to rest for 5 to 30 minutes, preferably 10 to 20 minutes, preferably 15 minutes.

In some embodiments, the lipid phase comprises lipids, in particular one or more oils, such as sunflower oil or cod liver oil.

In some embodiments, lipids different from the lipids added in step e) are added after the stirring step e) and the mixture is stirred again.

In some embodiments, the shear energy is applied to the mixture by applying shear forces in an air gap positioned between a rotor and stator.

In some embodiments, the mixture of step a) is stirred with the spatula.

In some embodiments, the mixture of step c) is stirred with the spatula.

In some embodiments, at step d), the mixture is stirred under shear in order to swell the phyllosilicate sheets in water, and to absorb the dispersant at the surface of the phyllosilicate particles, in order to make it compatible with the lipid phase;

In some embodiments, the mixture of step d) is stirred in a bladed disperser, preferably at 3500 rpm.

During step d), the water and the one or more water soluble antioxidants becomes located between the clay sheets and swells them. During this same step, the dispersant becomes located at the surface of the sheets, which will, on the one hand, make the clays “hydrophobic” and therefore assist their dispersion in the oil and, on the other hand, by intercalation of the dispersant between the clay sheets, facilitate the exfoliation and thus the dispersion of the clays in the oil.

In some embodiments, at step e), a shear energy is applied to the composition obtained in order to disperse/exfoliate the clay sheets in the lipid phase.

The shear at step e) can be produced by a shear applied in batches by means, for example, of a Silverson (shear rotor-stator), a complementary treatment by ultrasound, or using a high-pressure homogeniser to reduce the particle size.

### DESCRIPTION OF THE FIGURES

The invention is described below with the help of FIGS. 1 to 19, given by way of illustration only.

FIG. 1 schematically shows an oxidation mechanism of an unsaturated lipid;

FIG. 2 schematically illustrates a regeneration mechanism of vitamin E by vitamin C (Guilland, 2011);

FIG. 3 shows a diagram of a bentonite structure;

FIG. 4 shows the formula for lecithin;

FIG. 5 schematically shows the change over time in the lecithin content as a function of the specific area of the clay and for several degrees of coverage;

FIG. 6 shows a diagram of the change over time in the desorption energy of particles as a function of their size;

FIG. 7 shows the phase diagram of stability domains of emulsions obtained by the phyllosilicates;

FIG. 8 schematically shows the change over time in the size of the droplets of the dispersed phase as a function of the size and concentration of the mineral particles;

FIG. 9 shows the size of the mineral particles for two concentrations of clay;

FIG. 10 shows the change over time in the size distribution of particles of clay dispersed in a lipid phase during an additional treatment by ultrasound (US);

FIG. 11 shows the change over time in the size of droplets of the lipid phase as a function of the bentonite content;

FIG. 12 shows, for two tests, the size distributions of the mineral particles and oil droplets, as well as electron micrographs of the emulsions;

FIG. 13 shows the change over time in the peroxide value measured as a function time between compositions within without the exfoliated clay;

FIG. 14 shows a diagram of a first product;

FIG. 15 shows a diagram of a second product;

FIG. 16 shows a diagram of a third product;

FIG. 17 shows a diagram of measurement of the angle of contact between a pure water droplet and the surface of clays;

FIG. 18 shows the results of an evaluation of the antioxidant capacities of hydrophilic and hydrophobic molecules;

FIG. 19 shows the results of stability to oxidation of oil at ambient temperature (20° C.) and high temperature (120° C.) in the presence of simple compositions and of a composition in the form of an emulsion.

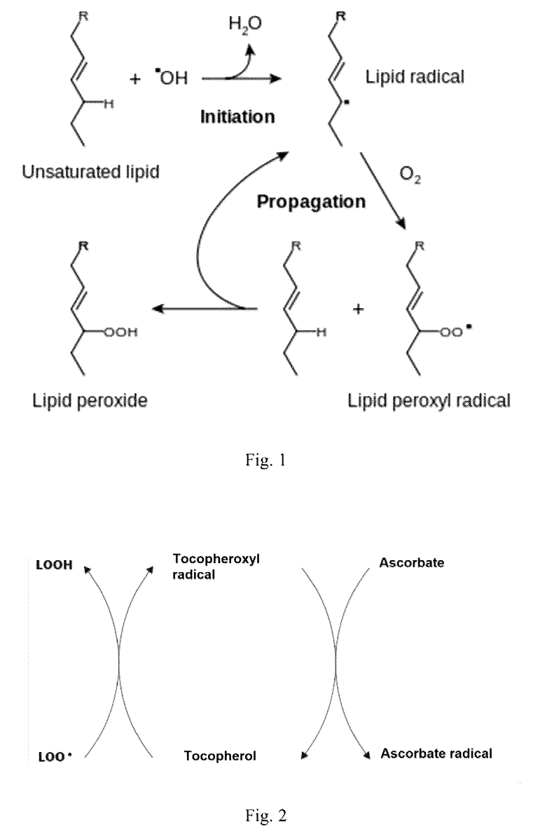

### DETAILED DESCRIPTION OF THE INVENTION

The term “object” or “feature” refers to the various constituent parts of foods or food supplements according to one of the objects of the invention.

The term “product” refers to the foods and food supplements according to one of the objects of the invention, obtained by stacking various objects.

The term “gel” means a material mainly consisting of liquid, but which has a behaviour close to that of a solid due to a three-dimensional tangled network within the liquid. It is these entanglements which give the gels their structure and their properties. The three-dimensional network of solids diluted in the liquid can be the result of chemical or physical bonds, or of small crystals or other bonds which promote organisation in the dispersion liquid.

An emulsion is of the “oil-in-water” type when (i) the dispersant phase is an aqueous phase and (ii) the dispersed phase is an organic (hydrophobic, lipid or oily) phase. Such an emulsion is also commonly referred to as a direct emulsion” or by the abbreviation “O/W”

An emulsion is of the “water-in-oil” type, when (i) the dispersant phase is an organic (hydrophobic, lipid or oily) phase and (ii) the dispersed phase is an aqueous phase. Such an emulsion is also commonly designated as an “inverse emulsion” or by the abbreviation “W/O”.

It is also possible to have so-called “double emulsions”, when an inverse emulsion is in turn dispersed in an aqueous phase. Such a double emulsion is a water-in-oil-in-water emulsion, designated by the abbreviation “W/O/W”.

Supramolecular structures are structures or organisations obtained at the molecular scale. These organisations are obtained by non-covalent interactions or weak interactions between atoms within a molecule or between molecules, within a molecular assembly. These molecular assemblies are nanometre-size structures, which can be organised on larger scales.

These self-assemblies will be able to produce more complex structures through non-covalent interactions, the shape and size of which are governed by physicochemical interactions on the molecular scale.

In the context of the present invention, “labile” molecule means a molecule bonded to a substrate by physical or ionic interactions, or non-covalent Van der Waals forces, which gives them a capacity for reversible attachment or organisation.

In the following, D50 by volume of a sample of particles is the particle size for which 50% of the volume of the particles of the sample have a particle size less than (or greater than) this value.

Preferably, the size of dispersed and exfoliated phyllosilicate particles ranges from 10 and 1000 nm, preferably 15 to 900 nm, more preferably 20 to 500 nm, yet more preferably 30 to 200 nm, still more preferably 40 to 100 nm.

### Composition According to the Invention

The present invention thus relates to a lipid composition comprising unsaturated lipids such as omega 3 and omega 6 and antioxidants. This composition is such that the antioxidants comprise water-soluble antioxidants stabilised by a supramolecular structure. The supramolecular structure includes water and a self-organised amphiphilic dispersant absorbed at the surface of clay sheets dispersed in the lipid composition.

The supramolecular structure thus comprises clay sheets, water absorbed or physically absorbed between the sheets and the amphiphilic dispersant bonded to the surface of the clusters of sheets by ionic interaction or Van der Waals bonds.

In other words, the supramolecular structure and the water-soluble antioxidants are dispersed in the lipids.

### Lipids

The lipids of the composition, either hydrophobic, or oily, or organic, are chosen according to the intended applications, from vegetable oils, mineral oils, synthetic oils, hydrophobic organic solvents and hydrophobic liquid polymers. The composition advantageously comprises unsaturated fatty acids, vitamins, antioxidants and essential oils.

Sunflower oil is used in the examples, with or without cod liver oil.

### Antioxidants:

The antioxidants of the composition according to the objects of the invention comprise water-soluble antioxidants. These water-soluble antioxidants or protective molecules are preferably chosen from the group consisting of reducing salts, such as Fe++, Cu+, etc., reducing enzymes, such as dismutases, oxidoreductases (such as laccases), flavonoids, phenolic derivatives (such as quercitins, isoflavones, anthocyanins, catechins, tannins, coumarins, etc.) and water-soluble vitamins. A preferentially used antioxidant is vitamin C. Water-soluble protective molecules play a double role: a protective role with respect to lipids, but also as a beneficial nutritional contribution in the daily food intake. The water-soluble antioxidant will be chosen to preferentially play the role of protective agent for lipids. This is the case for vitamin C, which will be consumed (sacrificial molecule) in the presence of reactive oxygen, in order to delay the action of this oxygen on the unsaturations of the lipids.

It should be noted that oils naturally include vitamin E at various contents. This liposoluble vitamin E has a protective role with respect to unsaturated lipids. FIG. 2 illustrates a regeneration mechanism of vitamin E by vitamin C. In a first step, vitamin E traps free radicals and forms a tocopheroxyl radical. Then, in a second step, the vitamin C reduces this radical to regenerate it into α-tocopherol and to generate an ascorbate radical. This is one of the plausible mechanisms for protection of lipids, given that vitamin C also has the possibility of capturing reactant oxygen radical species and thus reducing the probability of reaction with lipid unsaturations. In a last mechanism, vitamin C can also play the role of transfer agent for radicals to vitamin E, which increases the effectiveness of the protection of lipids by vitamin E, and reduces the presence of peroxide radicals on the lipids, and thus limits the propagation phase.

In certain embodiments, the water-soluble antioxidant is chosen from vitamin C, pomegranate or a pomegranate peel extract, grape extract, flavonoids, superoxide dismutase, glutathione and a mixture thereof.

In certain embodiments, the pomegranate extract comprises punicalagins and ellagic acid.

In certain embodiments, the grape extract comprises resveratrol.

The water-soluble antioxidants according to the invention have the advantage of being of natural origin. They are not harmful to the human body once ingested. Hence, when an excess of these molecules is present in the body, it is easily removed in the urine. By contrast, hydrophobic antioxidants, such as vitamin E, are bio-accumulated in the adipose cells of the body. Vitamin E is thus used in excess in weaning products for young animals or for humans, in order to protect vitamin A and provide a minimum of additions to the products. However, an excess of molecules such as vitamin A can have a negative physiological impact if it is over consumed.

Moreover the hydrophilic antioxidant molecules according to the invention are abundant natural resources, easy to access and low cost in comparison to hydrophobic antioxidants; having prices up to 100 times cheaper than vitamin E, for example.

These hydrophilic antioxidants are not however soluble in a hydrophobic medium such as oils. This problem is solved by the use of lecithin sheets with water absorbed in these sheets as a vehicle for conveying the hydrophilic antioxidants that are effective for the protection of oxidation-sensitive lipids.

### Phyllosilicates/Clays

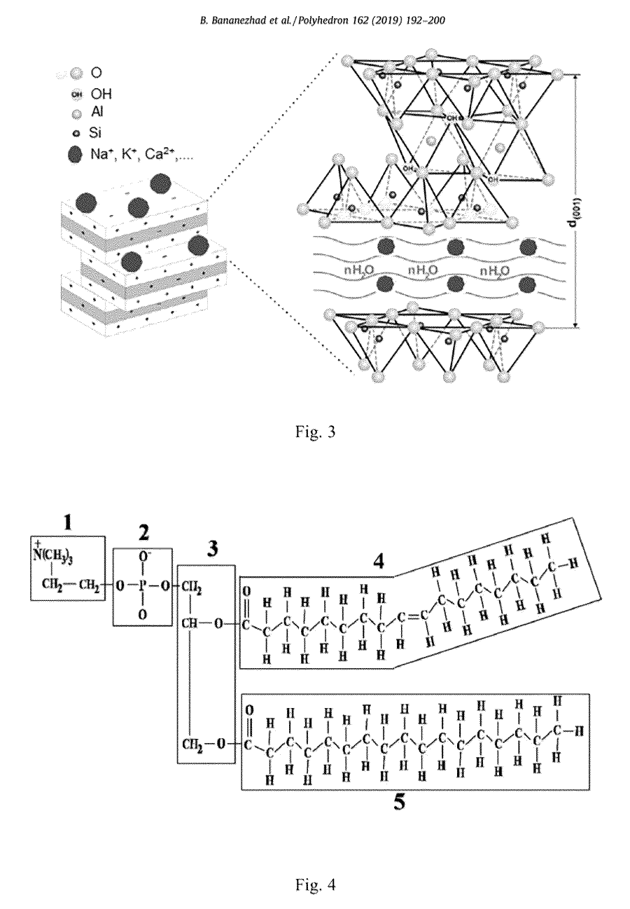

Phyllosilicates are clay minerals of the silicates group constructed by stacking tetrahedral layers (“T”) where the tetrahedra share three out of four vertices (the “basal” oxygens), the fourth vertex (the “apical” oxygen) being bonded to an octahedral layer (“O”) occupied by various cations (Al, Mg, Fe, Ti, Li, etc.). FIG. 3 shows an example of phyllosilicate structure. These stacked structures form organised sheets (as described in detail below) the surface charge of which is negative over a large range of pH (4<pH<9), which are stabilised by cationic counter ions. These counter ions are monovalent or divalent, which gives the clay a capacity to be swollen more or less strongly in water, by insertion of water molecules between the sheets.

The smectites are a group of clay minerals and are therefore silicates, more precisely phyllosilicates.

Their typical composition is A_{0.3}D₂₋₃T₄O₁₀Z₂·n H₂O, where A represents an interlayer cation (alkali or alkaline earth element), D an octahedral cation, T a tetrahedral cation, 0 oxygen and Z a monovalent anion (generally OH—).

They crystallise in the monoclinic system.

These are phyllosilicates of structure TOT (or 2:1), i.e. composed of sheets comprising two tetrahedral layers head-to-tail, bonded together by octahedral cations. The sheets are bonded together by interlayer cations.

It is possible to distinguish between the dioctahedral smectites (beidellite, montmorillonite, nontronite, etc.) and trioctahedral smectites (hectorite, saponite, etc.).

Montmorillonite is a clay of type 2/1, also referred to as TOT (for tetrahedron/octahedron/tetrahedron). This means that a sheet of montmorillonite is formed of three layers:
an octahedral layer Al(OH⁻)₅O: 7 atoms for 6 vertices+aluminium at the centre. The OH⁻ and oxygen being shared between the various octahedra which compose the layer.
and two tetrahedral layers which cover each side of the octahedral layer at its base; SiO₄: 5 atoms for 4 vertices+silicon in the middle. The oxygens being shared between the various tetrahedra which compose the layer.

The imperfections in the crystal are compensated by interlayer cations, generally monovalent or divalent, which ensure the electrical neutrality of the mineral.

All phyllosilicates can be used, but smectites and particularly montmorillonites are advantageous, due to their lamellar structure with a larger gap between the sheets than other phyllosilicates, being able to be swollen by small molecules such as water molecules which will improve the exfoliation of the clay platelets and thus facilitate their dispersion in the composition. Other phyllosilicates, but also micas and talcs, can also be exfoliated in this way, but the energy which would be necessary to disperse the lamellar sheets in the lipid phase would be much higher.

Bentonite is used as the phyllosilicate in the examples. Bentonites are clays mostly composed of montmorillonite, for which the interlayer cations are usually either calcium, sodium or potassium, a combination thereof or other metal ions.

Bentonite is negatively charged at the surface (over the length) and positively on the sides (width), which enables it to interact with other charged molecules.

Clays are hydrophilic and smectites, including bentonite, have the capacity to swell. This peculiarity allows water-soluble molecules to be absorbed in the interlayer space of the clays by means of an aqueous phase. Water is said to be physically absorbed at the surface of clay sheets via the silanol groups.

In the description, the term “clay” or “mineral particle(s)” is used to refer to phyllosilicates.

### Dispersant or Surfactant

A molecule having a hydrophobic part and a hydrophilic part is usually used as dispersant or surfactant. The adhesion of this dispersant by physical interaction with the mineral particles makes it possible to make the clay sheets hydrophobic and to obtain a good dispersion of these clay sheets in a lipid phase.

It is advantageous to use a dispersant having a cationic polar head and a hydrophobic chain, soluble in the lipid phase, such as phospholipids having cationic polar functions, such as serine, ethanolamine or even choline. Thus, phosphatidylserine, phosphatidylethanolamine, or even phosphatidylcholine is obtained, better known under the name “lecithin”. This is a phosphoglyceride-class lipid. Arginine grafted on a long alkyl chain (C16 and more) can also play this dispersant role. Ethyl lauroyl arginate (LAE) can be used.

All these dispersants are labile because they bond to the surface of the clusters of lecithin sheets by non-covalent interactions, which gives them a capacity for reversible attachment or organisation.

Phosphatidylcholine has (FIG. 4):
a hydrophilic pole: choline (1) and the phosphate group (2);
a hydrophobic tail: fatty acid residues (here, the residues of palmitic acid (5) and oleic acid (4)); and
glycerol (3) bonds these two hydrophilic and hydrophobic poles.

The phosphate group is negatively charged, while the choline is positively charged. The phosphatidylcholine is therefore zwitterionic.

It is both hydrophilic and lipophilic, and its hydrophilic-lipophilic balance (HLB) can vary between 2 and 9.5 according to the fatty acid residues of the hydrophobic tail.

### Dispersion/Exfoliation of Clay, in Particular Bentonite, in Oil

The objective of this step is to obtain the composition according to the objects of the invention.

The invention also relates to a method for dispersion and exfoliation of phyllosilicates in the lipid phase.

In order to combine two systems which originally have no affinity, one being apolar (the lipids) and the other polar (aqueous phase+clay+water-soluble antioxidants), the following steps are performed:
(1) dissolving the one or more soluble antioxidants in water;
(2) adding the dispersant and obtaining a homogeneous mixture;
(3) adding the clay and shearing the composition obtained in order to swell the phyllosilicate sheets by swelling in water, and absorbing the dispersant at the surface of the phyllosilicate particles, in order to make it compatible with the lipid phase;
(4) adding the lipids;
(5) applying the shear energy to the composition obtained, in order to disperse/exfoliate the clay sheets in the lipid phase.

Steps (1) and (2) are obtained by adding a sufficient quantity of water to solubilise the antioxidants and impregnate the clay sheets. It is advantageous to use between 1 wt % and 40 wt % of water relative to the weight of the complete lipid phase, and preferably between 4 and 25%.

Clays are known for their water absorbent properties, and they can swell, depending on their chemical and structural composition, to between 2 times their mass in water, and up to 20 times their mass in water. Clays swollen in this way form a gel, the more or less swollen and more or less exfoliated sheets of which incorporate the entire volume of water. It is not necessary to saturate all of the water-absorption capacity of the clays in order to obtain a satisfactory dispersion of the clay in the lipid phase; this is why the addition of water is limited to 300 wt % relative to the clay. On the other hand, it is necessary that the clays are at least impregnated with water in order to promote their dispersion. The clays which can be exfoliated are usually kept at a humidity level of 10%. It is essential not to go below the threshold of 5% in order to avoid the collapse of the phyllosilicate sheets, leading to a structure which loses its exfoliation capacity.

An insufficient water content does not allow the solubilisation of the molecules of interest.

When the water content is too high, the clay sheets are easier to exfoliate but they are impregnated with water and they have less capacity to absorb lecithin molecules. There is no possibility of forming a supramolecular structure necessary for the effectiveness of the protection.

Step (3) is obtained by using a dispersant, such as lecithin as dispersant/exfoliant. This will absorb on the surface of the clay sheets by ionic interaction between the polar head of lecithin and the silanol groups of the clays. Lecithin is pre-dissolved in the water of step (1) in order to facilitate its incorporation. The quantity of lecithin can vary between a degree of coverage of the clay surface from 5% to 100%. This degree of coverage is calculated as a function of the total outer surface of clay after exfoliation, and the number of anionic charges at the surface of the sheets (usually there is of order five silanol functions per square nanometre, 5/nm²) accessible by lecithin (the most swollen sheets (separated by water)). It therefore depends on the specific surface area of the clay accessible by the dispersant.

Consequently, it is necessary to work on various contents of dispersant, depending on the clays used, which will present sufficient quantities of silanols accessible to the lecithin molecules. It is necessary to target the optimum degree of coverage between 20% and 60% of surface silanols of the particles depending on the particle size and the desired hydrophobicity. Hence, various types of particles can be prepared in order to stabilise the direct or inverse emulsions.

Advantageously, the exfoliation step of the clay is carried out at a pH ranging from 5 to 10, preferably 7 to 9. Exfoliation in this pH range enables optimum swelling of the clay.

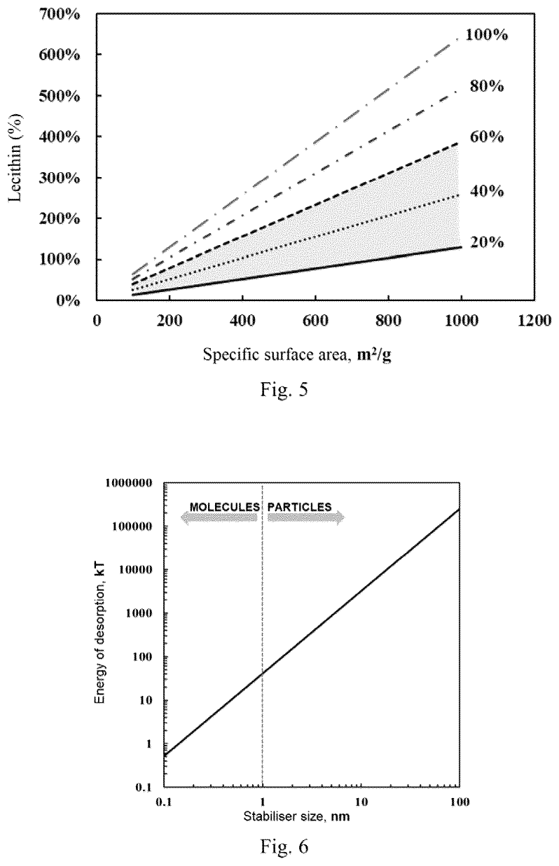

FIG. 5 schematically shows the change over time in the necessary lecithin content by weight, relative to the content by weight of clay, as a function of the specific surface area of the exfoliated clays, for several degrees of coverage of silanols of the clay sheets by lecithin.

This figure shows that the optimum lecithin content for obtaining good exfoliation followed by a stable direct or inverse emulsification is between 13 mass % and 129 mass % relative to the mass of the clay for a degree of coverage of 20% and respectively a specific surface area of clay of 100 m²/g and 1000 m²/g. For a degree of coverage of 60% the optimum lecithin content is between 39% and 387 mass % relative to the mass of clay and respectively a specific surface area of clay of 100 m²/g and 1000 m²/g.

When the content of dispersant, such as lecithin, is insufficient, the hydrophobic character of the clay particles is insufficient.

When the quantity of dispersant, such as lecithin, makes it possible to cover the surface silanols of the particles, the dispersion of clays in the lipid phase is favoured. At degrees of coverage close to 100%, the hydrophilic character is lost, which gives an excellent stability to the clay particles in the lipids.

There is a competition between the dispersant, such as lecithin, and the water molecules for physical absorption or adsorption at the surface of clays, therefore an excess of lecithin will be unfavourable to the absorbable quantity of water and, consequently, to the quantity of stabilised antioxidant molecules at the clay-lipid interface in the composition.

For the bentonite used, with a specific surface area of order 300 m²/g, it is therefore necessary to have an optimum content of lecithin of order 30 to 130 wt % relative to the mass of clay with a degree of coverage between 20 and 60% of the surface silanols of the clay.

Step (5) can be obtained by a shear applied in batches by means, for example, of a Silverson (shear rotor-stator), a complementary treatment by ultrasound or using a high-pressure homogeniser is also possible in order to reduce the particle size.

The term “shear of a liquid composition” means the application of shear forces in an air gap positioned between a rotor and a stator. This air gap can be, depending on the equipment, between 0.1 mm and 2 mm. This shear force in the air gap is expressed in the form of a shear gradient, which will be steeper the higher the speed of rotation, the higher the diameter of the rotor and the smaller the air gap. In commercial equipment, the rotor speed can vary from a few rpm up to 12,000 rpm. In order to translate the parameters into universal values that can be used on any type of equipment, the speed at the end of the rotor is determined, which must be of order 2.5 m/s, for an air gap 150 μm on the M5 equipment from Silverson.

It is important to apply the correct speed in order to provide the correct level of energy which can fracture the emulsion droplets to the correct size, while the processing time makes it possible to obtain a good processing homogeneity of the volume to be emulsified.

A variation in the speed (shear gradient) makes it possible to modulate the size of the emulsions, which will vary between 1 μm at 10,000 rpm, and 70 μm at 1000 rpm. The processing time is determined for this equipment for maximum emulsion volumes of 3 L.

The invention also relates to a lipid composition obtained by this dispersion and exfoliation method.

### Method for Obtaining an Emulsion

In order to stabilise the emulsions, one approach consists of employing so-called “emulsifier” or “emulsifying” compounds.

These emulsifying compounds are most often emulsifying surfactants which, due to their amphiphilic structure, locate at the oil/water interface and stabilise the dispersed droplets.

However, emulsifying compounds of this type do not always offer the desired stability over time, with a permanent equilibrium of surfactants between the interface to be stabilised and the micelles in solution. Moreover, synthetic surfactants often have disadvantages on the ecological or food plane because they disturb biological systems through a strong reaction with cell membranes.

These emulsifier/emulsifying compounds can also consist of solid particles, which enables so-called “Pickering emulsions” to be obtained.

Pickering emulsions are emulsions which are stabilised by colloidal particles in suspension in the aqueous phase and anchoring at the oil/water interface, interpreted as a wetting effect at the interface of the two phases, with a high stability.

In contrast to the surfactants which are continuously absorbed and desorbed under the effects of thermal agitation, the particles in colloidal suspension are strongly absorbed at the interfaces and the desorption energy of the particles, as illustrated in FIG. 6, becomes sufficiently high to make the phenomenon irreversible.

Phyllosilicate particles thus have an emulsifying role for stabilising the emulsions according to one object of the invention. These emulsions are thus Pickering emulsions.

The objective of this step is to obtain a stable emulsion with a dispersed phase in the form of droplets in a continuous phase. The lipid phase comprises the dispersion of phyllosilicates in the previously described oil. The aqueous phase is composed of water to which a monovalent salt can be added, with a concentration between 0 and 100 mM in water, advantageously with NaCl at a concentration less than 50 mM and very advantageously at 25 mM. This ionic force has been chosen in order to limit the electrostatic repulsions due to the surface charges of the clay particles. In order to disperse the two immiscible phases, a shear energy will be applied in batches, at ambient temperature, using for example a rotor/stator device with an air gap of 150 micrometres with a 30 mm spindle, at a speed of 2000 to 5000 rpm for 3 to 30 minutes, preferably 400 rpm for 5 minutes, yet more preferably at 4500 rpm for 4 minutes.

To obtain an emulsion according to one of the objects of the invention, a lipid phase is always used in which clay particles are dispersed and stabilised with a dispersant or surfactant in the presence of water, as described above.

The direct or inverse character of the emulsion obtained is mainly a function of the relative viscosities of the continuous phase and the dispersed phase, the proportion of dispersed phase (less than 30 wt %) relative to the continuous phase at the start of emulsification, given that the dispersed phase can then be added, dropwise, in order to increase the proportion. It is thus possible to produce emulsions with more than 65 wt % dispersed phase.

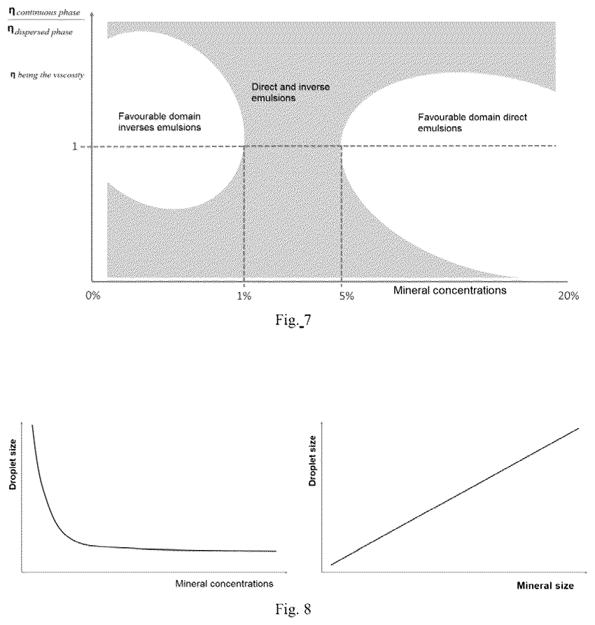

FIG. 7 shows the domains in which direct and inverse emulsions are mainly obtained, as a function of the concentration by weight of clays in the lipid phase on the x-axis and the viscosity ratio of the continuous and dispersed phases on the y-axis. Of course, this figure is only one scheme and other factors can intervene, for example the ratio of the weights of water and oil.

When the concentration of mineral particles in the lipid phase is low, less than 1 wt % relative to the weight of the lipid phase, the viscosity of the lipid phase decreases and the ratio of the viscosities of the two phases increases, approaching 1 and above, and the conditions are favourable for obtaining inverse emulsions.

By contrast, when the concentration of mineral particles in the lipid phase is high, greater than 5 wt % relative to the weight of the lipid phase, the viscosity of the lipid phase increases and the ratio of the viscosities of the two phases decreases. These conditions are favourable for obtaining direct emulsions.

The droplet size of the dispersed phase obtained is a function of the size of clay particles and of the concentration of these clay particles. FIG. 8 schematically shows the changes observed.

For a given size of clay particles, the diameter of droplets decreases with the concentration; the more particles are added, the more interfaces they can stabilise and thus the result is droplets of the dispersed phase with smaller diameters. However, the size of the clay particles will impose a minimum size of droplets; droplets cannot be made smaller than the stabilising particles.

Advantageously, the size of the lipid droplets in an emulsion according to the invention ranges from 5 to 100 μm, preferably 10 to 80 μm, more preferably from 15 to 70 μm, yet more preferably from 20 to 60 μm.

It should be noted that the stabilisation of the emulsion droplets by clay particles induces a stiffening of the interface with droplets which lose their sphericity. Furthermore, the size limit for droplets observed on the plateau at high concentration of clay depends on the shear energy applied in order to fragment the droplets.

The emulsions stabilised by phyllosilicates organised at the surface of the droplets, makes it possible to have lipid droplets stabilised against coalescence by a physical barrier with dominant negative charge at the surface for a wide range of pH ranging from pH 4 to pH 10.

This negative charge is provided by the surface silanolate bonds of the clay platelets. These negatively-charged silanolates can interact with molecules (L-arginine, L-Lysine) or cationic polymers (chitosan, hyaluronic acid, polylysine, etc.), which makes it possible to change the surface interactions of the droplets and thus the functionality, or to change their attractiveness for various supports. It is also possible to functionalise them by covalent bonding, by condensation of silanes prepared for providing particular functions. A diversity of silanes that can be condensed by one or more silanes is possible. Examples include mono-, di- or tri-ethoxyaminopropylsilanes. Many molecules can be used to then covalently couple the amine function provided by the silanes. A simple chemistry can be used with coupling agents, such as isothiocyanates, N-hydroxysuccimide ester (NHS-ester), isocyanates, acyl azides, sulfonyl chlorides, aldehydes, glyoxals, epoxides, oxiranes, carbonates, aryl halides, imidoesters, carbodiimides, anhydrides, and fluorophenyl esters

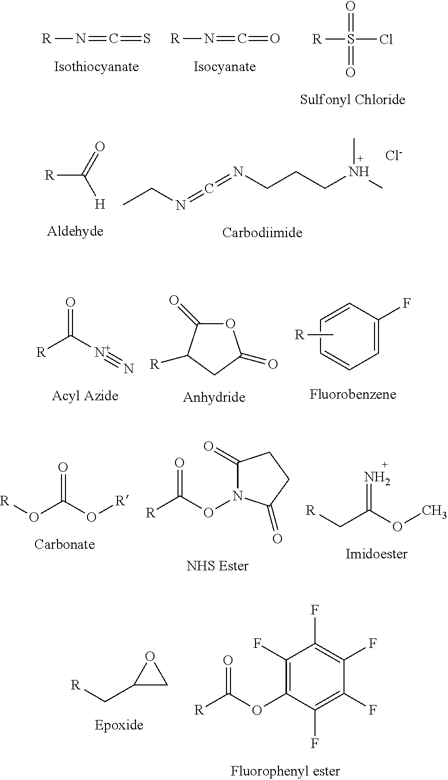

The surfaces of the particles can thus be functionalised in order to interact with surface antigens on the bacteria, or bacterial biofilms.

Food or Food Supplement with Direct Emulsion Included in a Hydrophilic Matrix

FIG. 14 shows, schematically and in cross-section, without respecting the respective dimensions of each phase, a first food or food supplement example obtained with a direct emulsion according to one of the objects of the invention.

This product 10 comprises a core 12 and a coating 14 of the core. The core 12 comprises a lipid phase as described above, in the form of stabilised spherical particles 18 dispersed in a hydrophilic matrix 16 thus constituting a direct emulsion introduced into this matrix.

A first feature or object of this product 10 is the presence of lipid particles 18 as described above, dispersed in the hydrophilic phase or matrix 16. These lipid particles 18 include mineral particles, i.e. phyllosilicates and preferably smectites and very preferably mostly including montmorillonites.

The lipid particles 18 as described above also include a lipid-based or phospholipid-based dispersant, with a cationic head, and preferably choline, a preferred example of a disbursement is lecithin. These dispersants combined with water can solubilise antioxidants such as vitamin C and form a supramolecular structure as described above. These dispersants can also obtain good exfoliation and dispersion of mineral particles in the lipid phase, beforehand or simultaneously with the production of the direct oil/water emulsion. Mineral particles can, in particular during the production of the oil/water emulsion, stabilise the size of the lipid particles 18 during the preparation of the foods or food supplements 10, but can also strongly reduce migration of nutrients and physiologically active substances between the two lipid and hydrophilic phases 16, as well as the migration of pro-oxidant agents such as the O₂ radicals.

According to preferred embodiments, the lipid particles 18 are substantially spherical and of diameter between 1 and 100 μm, and preferably between 5 and 20 μm.

The lipid particles 18 can advantageously include polyunsaturated fatty acids, vitamins and antioxidants, essential oils.

The lipid particles 18 comprise one or more vegetable or animal oils, preferably chosen from oils having a high content of omega 6 and omega 3. These lipid particles 16 preferably have a high content of omega 6 and omega 3, in particular of the DHA and EPA types. The omega 3 content is preferably greater than 2 wt % relative to the weight of the lipid phase, i.e. lipid particles 18.

A second feature or object of the product 10 is to have an aqueous phase 16 containing nutritive substances or water-soluble active substances, and gelling agents.

The terms “aqueous phase”, “hydrophilic matrix” and “aqueous matrix” will be used interchangeably.

Advantageously, the aqueous matrix 16 has a substantially spherical or non-spherical shape depending on the manufacturing method, and has a diameter less than 5 mm and preferably between 10 and 1000 μm.

The gelling of the aqueous phase 16 makes it possible to limit the leakage of nutrients and active substances to the outside when it is immersed in an aqueous medium.

To obtain this gelling, the aqueous phase 16 can advantageously include a polysaccharide that is neutral or functionalised, with at least one function chosen from the carboxylic, sulfonate, alkoxide or phosphate functions, and preferably the carboxylic function, with a content between 1 and 8 wt %, preferably between 1 and 5.5 wt % relative to the total weight of a dry extract of the aqueous phase 18.

Advantageously, the aqueous phase 16 is gelled (cross-linked) by reaction of the polysaccharide with reagents such as multivalent cations in the presence of pyrophosphate or delta-gluconolactone, by release of acid protons by aqueous hydrolysis, then solubilising (release) of multivalent cations.

The multivalent cations are preferably chosen from the group consisting of cations of calcium, magnesium, zinc and combinations thereof.

Advantageously, the multivalent cation is a calcium salt chosen from the group consisting of carbonate, sulfate, lactate, citrate, tartrate, caseinate and stearate.

According to a preferred embodiment, the emulsion of lipid particles 18, as described above, dispersed in the aqueous phase 16, includes specific proteins or biopolymers intended to modify the interfacial properties between the lipid particles 18 and the aqueous phase 16.

These properties can be the permeability, the electrostatic surface charges, surface tension, chemical functions, roughness, etc.

The molecular weight and pKi of these proteins or these biopolymers can be the criteria of choice. By way of example, it is possible to use BSA proteins (Bovine Serum Albumin), for which the molecular weight is of order 66 kDa and pKi is 5.2; it is also possible to use lysozyme proteins with molecular weight of order 14 kDa and pKi equal to 11.35. Biopolymers such as chitosan, with molecular weight that can vary from 75 kDa to 500 kDa, can also be used. These macromolecules are added to the aqueous phase 18 after establishing the so-called Pickering lipid emulsion.

The gelled aqueous phase 16 also optionally includes an exfoliated mineral of specific surface area greater than 100 m²/g, advantageously between 200 and 500 m²/g,

This mineral filler can be chosen from the group of phyllosilicates, and the phyllosilicate is preferably a smectite.

Preferably, the content of the lipid dispersed phase in the aqueous matrix 16 is between 5 and 70 vol %, and preferably between 10 and 20 vol % for whole foods and between 45 and 70% for food supplements, relative to the total volume of the core 12.

Below 5 vol %, the volume of the lipid phase is no longer sufficient to easily introduce the liposoluble active substances and to have a good homogeneity of composition of the cores 12 of the 10 products.

Beyond 70%, it becomes much more difficult to preserve an emulsion of oil dispersed in the aqueous phase 16 (the matrix no longer retains the droplets of emulsion, because the gel lattice is too weak).

The gelled aqueous phase 16 can contain hydrophilic active substances such as proteins, amino acids, vitamins, prebiotics, probiotics, antioxidants and combinations thereof.

Advantageously, the aqueous phase 16 also includes an osmotic agent.

This osmotic agent can be chosen from the group consisting of sugars, salts, water-soluble polymers preferably of molecular weight less than 150 kg/mole and combinations thereof.

A preferred choice of osmotic agent can be sorbitol with a content less than 5 wt % relative to the weight of the aqueous solution, i.e. of the aqueous phase 18 (in its complete formulation) in order not to make the final product indigestible. A content between 0.8 wt % and 1.5 wt % sorbitol is optimum. Advantageous use of Guerande salt is also possible, which can also contribute useful mineral salts.

The third feature of this product 10 is to include a coating 14 of the core 12.

Advantageously, the core 12 includes free charges at the surface, the coating 14 of the core 12 includes n layers C of materials M+ and M− that are biocompatible with a digestive system, in particular biopolymers, having an alternating stack of positive and negative electrostatic charges which form structured coacervates by stacking layers, and n is equal to at least 1.

This coating 14 can include n layers C of biocompatible materials M+ and M−, in particular biopolymers, with an alternating stacking of positive and negative electrostatic charges which form cross-linked and structured coacervates by stacking of layers, and n being equal to at least 2.

This system of coating 14 has the advantage of facilitating the modulation of the thickness of the layer of coating 14, and the large choice of biocompatible materials, in particular biopolymers, M+ and M−, makes it possible to modulate the mesh of biocompatible materials, in particular biopolymers, M+ and M−, at the surface, which is also stiffened by cross-linking of greater or lesser strength of this mesh. The modulation of the stiffness of the coating 14 makes it possible to modulate the release of nutritive and/or physiologically active substances: the denser the stiffening, the more the meshing of biopolymers is reduced and the more the release is slowed down. This type of cross-linked and structured coating 14 in multiple layers C also makes it possible to obtain a structural stability necessary for the preservation of the food 10 until its consumption and the release of nutritive and/or physiologically active substances, and in particular necessary for its handling.

This product 10 has strong potential for the effective substitution of live prey in hatcheries form marine fish species, as well as for shrimp nurseries. It is also of great interest for supplementing drinking waters for monogastric farms such as poultry farms.

This product, which is illustrated in FIG. 14, can be produced as follows. A direct O/W emulsion is prepared, stabilised by bentonite particles dispersed in the oily phase according to the method of the invention. Then, after gelling the aqueous phase, the cores 12 can easily be obtained by mechanical cutting. A double water-in-oil-in-water emulsion can also be produced, stabilised by gelling of the aqueous phase, and recovering the cores 12 by separation between the oil phase and the washing water, for example by centrifugation. The coating 14 is then produced.

Lipid Product with Particles at the Rigid Interface from a Direct Emulsion

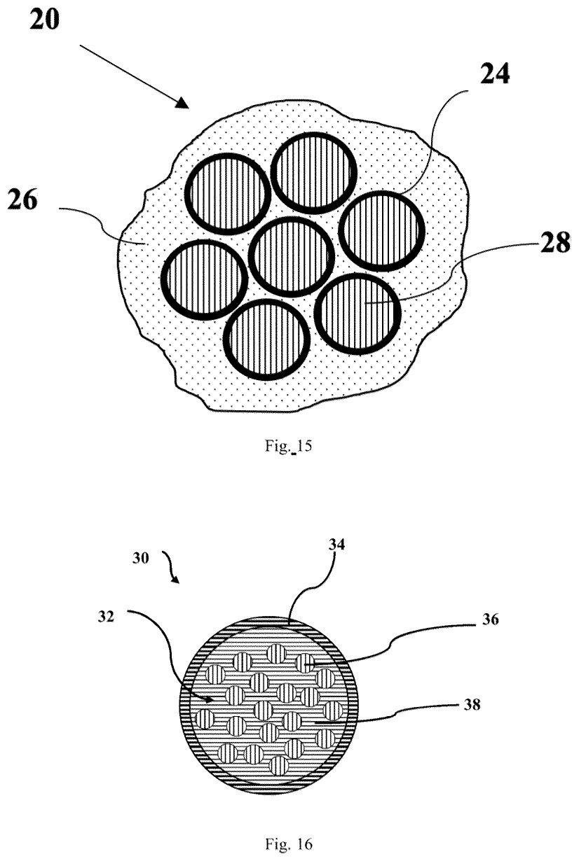

FIG. 15 shows a lipid product 20 which is a direct application of a lipid composition according to one of the objects of the invention formed as a direct O/W emulsion.

Lipid particles 28 can be seen, as described above surrounded by a coating 24 and dispersed in an aqueous phase 26.

The lipid particles or droplets, which have a supramolecular structure as described above, are also stabilised by the dispersed mineral particles of phyllosilicate. They are advantageously coated after they are obtained. This coating is intended to make them more mechanically robust and tolerant to deformation, without breaking. It also makes it possible to limit the risks of leaching of the contents of the lipid droplets into the aqueous phase. This coating can advantageously be chitosan, polylysine or hyaluronic acid.

This lipid product is obtained from a direct oil/water emulsion, obtained by dispersion of a composition as described above in the oil. The emulsion can be concentrated by separation of the aqueous phase, this separation can be produced by any means, in particular by centrifugation.

The lipid particles preferably have a size in the order of 1 to 20 μm. This very small size gives them good mechanical strength. With a coating of chitosan, these lipid particles can be used, in particular, to provide a lipid phase in direct use (food for zooplankton) or by incorporation in food premixes or food supplements, even when these are obtained by an extrusion process.

Advantageously this emulsion can be a double emulsion for conveying sensitive water-soluble nutrients such as prebiotics, enzymes, antioxidants, vitamins, or peptides.

Food or Food Supplement at the Rigid Interface Coming from a Double Emulsion

FIG. 16 shows a third food or food supplement obtained by using a composition according to one of the objects of the invention in the form of a W/O/W double emulsion.

This product 30 comprises a core 32 and a coating 34 of the core. The core 32 comprises an aqueous phase in the form of spherical (or irregular) particles 36, and the particles 36 are dispersed in a lipid matrix 38 as described above. This is an inverse emulsion.

A first feature or object of this third product is that it contains an aqueous phase that is optionally gelled, containing water-soluble active substances, including in particular nutrients.

Advantageously, the size of the aqueous particles 36 is between 0.1 and 50 μm and preferably between 0.5 and 20 μm.

Advantageously the aqueous particles 36 are stabilised by phyllosilicates dispersed in the lipid phase as described above.

Advantageously, an optional gelling is applied to the aqueous phase, which makes it possible to limit the leakage of nutrients and active substances out of the particles 36. It also makes it possible to modulate the rate of release of the active substances that they contain, in the digestion phase.

The aqueous phase can advantageously be gelled by reaction of an anionic polysaccharide, advantageously functionalised with a carboxyl, with reagents such as a calcium salt as well as pyrophosphate or delta-gluconolactone.

Advantageously, the aqueous phase can also include an osmotic agent. This can be chosen from the group consisting of sugars, salts, water-soluble polymers preferably of molecular weight less than 150 kg/mole and combinations thereof.

Preferably, the content of the aqueous phase dispersed in the lipid matrix 38, and hence the content of optionally gelled particles 36, is between 10 and 50 vol %, and preferably between 15 and 30 vol % relative to the total volume of the aqueous phase and of the lipid phase 38, i.e. relative to the total volume of the core 32.

As in the case of the first food or food supplement described, the optionally gelled aqueous phase, and hence the optionally gelled particles 36, can include hydrophilic active substances such as amino acids, vitamins, prebiotics, enzymes, probiotics, mineral salts, antioxidants, and combinations thereof.

A second feature or object of this third product 30 is that the aqueous phase, i.e. the particles 36, is dispersed in a lipid matrix or phase 38 as described above.

Advantageously, the second object or feature of the product 30, the lipid matrix 38 includes a supramolecular structure as described above. This lipid matrix includes at least one vegetable or animal oil, in particular fish oil, water-soluble antioxidants, an exfoliated mineral filler, namely phyllosilicates and preferably smectites, and optionally at least one crystallisable wax. The mineral particles, i.e. phyllosilicates, dispersed in the lipid matrix enable the stabilisation of the particles 26 of the aqueous phase in the inverse emulsion.

The waxes can be of animal (beeswax) or vegetable origin.

According to preferred embodiments, the lipid phase 28 is substantially spherical and thus the core 32 is substantially spherical and of diameter between 1 and 1000 μm and preferably between 5 and 400 μm.

The lipid phase 38 can advantageously contain vitamins.

Preferably, this lipid phase 38 has a high content of omega 6 and omega 3, in particular of the DHA and EPA types.

The lipid phase 38 advantageously comprises at least 1 wt % omega 3 of the DHA and EPA types, relative to the weight of the lipid phase 18. It also preferably comprises less than 50 wt % omega 3 of the DHA and EPA types and very preferably less than 20 wt % relative to the weight of the lipid phase 38.

According to an advantageous embodiment, the content of the mineral filler in the lipid phase 38 is between 0.5 wt % and 35 wt % and preferably less than 15 wt %, in other words between 0.5 wt % and 15 wt %, relative to the weight of the lipid phase 38.

The third feature or object of this third product 30 is to include a coating 34 around the core 32, of at least one layer of chitosan. This coating can advantageously be identical to that of the first product.

The core or cores 32 are prepared from a water-in-oil-in-water double emulsion. The coating 34 is then produced, followed by filtration or decantation. Finally, drying is performed in order to bring the moisture content of the products to a value less than 10 wt %, relative to the total weight of the product 30. This last step is optional.

### Materials and Methods

The clay used is bentonite: Oscoma company (Ulm, Germany); the lecithin is of brand Seah International (Wimille, France); Vitamin E: Roth (Karlsruhe, Germany); Vitamin C: meszepices (Dierrey Saint Pierre, France).

### Method 1: Particle Size Measurements of a Lipid Dispersion (DLS)

The size of the mineral particles obtained in a lipid medium is measured by dynamic light scattering (DLS). The experiments were carried out with a Malvern Nano ZS instrument. All the measurements were carried out at a temperature of 20° C. with a single detection at 173°. The hydrodynamic diameter was obtained from analysis of the correlation function using the Malvern DTS software, and by making the approximation of a spherical shape of the particles or clusters of lecithin sheets, taking into account the largest dimensions of the particles. The viscosity of the sunflower oil was 66 cSt.

The tested sample is produced by dilution to a concentration of 0.1 wt % of particles relative to the weight of the medium (water or oil). The tested sample is stirred with a vortex, 1 minute before the measurement.

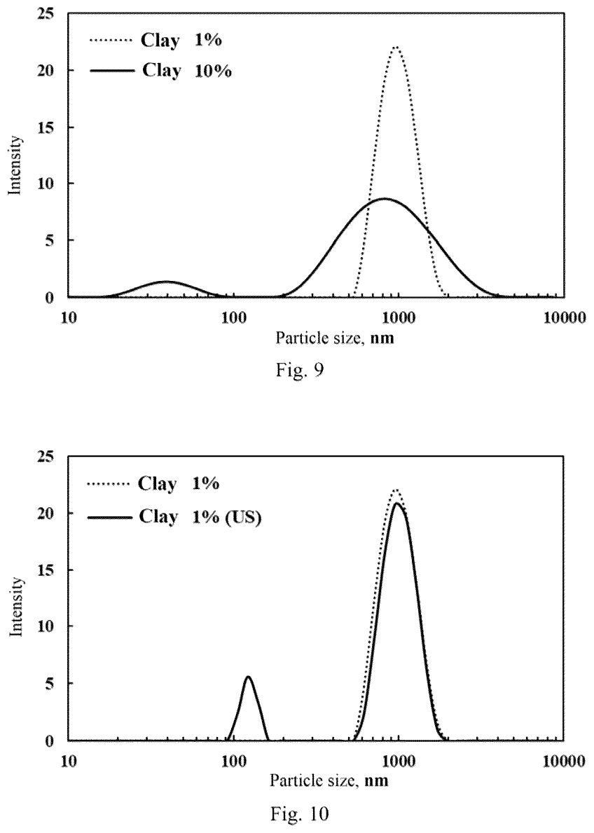

FIGS. 9, 10 and 12 show the change over time in the number of particles as a function of their size, using semi-logarithmic coordinates.

### Method 2: Droplet Size Measurements of a Direct or Inverse Emulsion (Particle Size Analyser)

The average individual diameters of the droplets were measured by laser light diffusion using a particle size distribution analyser Horiba LA-960 (Kyoto, Japan). An analysis model was used with a refractive index of 1.54 and 1.33 for the oil and water, respectively. Calibration of the water as reference was carried out before each measurement. All the emulsions were measured in a transmittance range between 80 and 90%. The measurements were systematically carried out in triplicate. The diameter was expressed as the number average diameter.

### Method 3: Contact Angle Measurements

A measurement of the contact angle between a drop of pure water and the surface of the clays at the end of step (3), i.e. before adding the lipids (4) and the shear energy (5), made it possible to check that the quantity of dispersant or surfactant was satisfactory. In order that the clay sheets can fulfil their role as mineral emulsifying particles, it is necessary that the contact angle is between 35 and 45 degrees and preferably between 37 and 42 degrees. Beyond the indicated values, the stability of the emulsions is not sufficient. A contact angle less than 30 degrees indicates that the surface of the clays is too hydrophilic for stabilising the emulsions. An angle greater than 50 degrees indicates that the surface is too hydrophobic for stabilising the emulsions.

The clays are deposited in a thin layer, using a spatula on a flat solid support. In order to limit the effects due to irregularity (roughness) of the surface, droplets of pure water of 2 μL only, are deposited on the clays. The images obtained during the depositions also make it possible to consider that the wetting obeys the Wenzel model. The surface roughness obtained with the various clays can be considered as relatively similar, the contact angles measured are considered as representative of the wettability of the clays, even if the values are slightly less than the angles which would be obtained on the same surface in the smooth state.

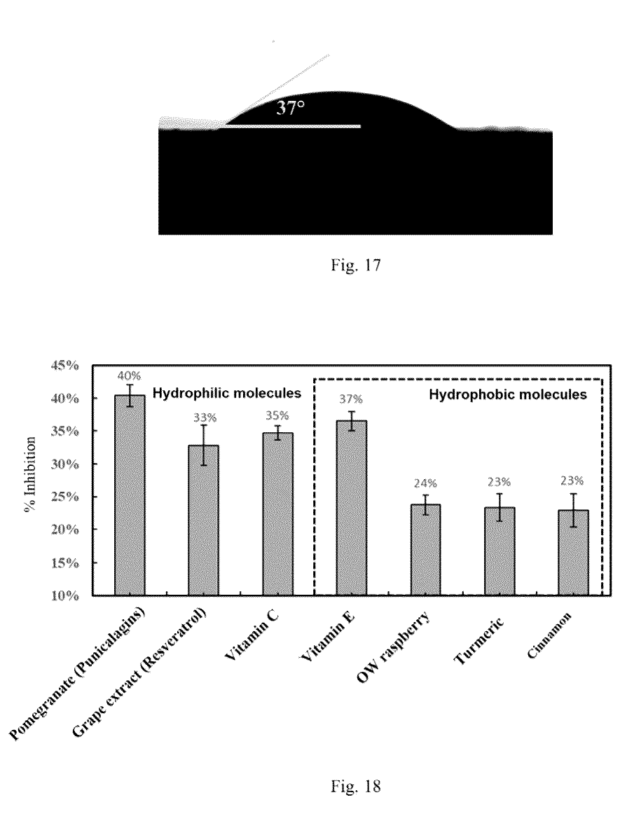

When the equilibrium state is reached, the deposited drop is observed using a high-magnification digital camera and the equation for the envelope of the drop is obtained by non-linear regression, assuming that the envelope of the drop follows the shape of an ellipse. The contact angle is obtained by measurement of the slope of the tangent at the envelope of the drop, at the point of intersection with the line parallel to the plane of the clay layer (see FIG. 17).

Each liquid is deposited at two different locations on the layer of clay, and the contact angle of each drop is measured three times. The absolute error on each angle measurement can be estimated at +/−2 degrees.

The measured contact angle is 37 to 39°.

Hence the clay particles obtained according to the method of the invention will lead to obtaining stable emulsions after steps (4) and (5).

### EXAMPLES

### Example 1: Protocol for Evaluating the Antioxidant Capacity of Antioxidant Molecules

FIG. 18 shows an evaluation of the antioxidant capacity of hydrophilic and hydrophobic molecules.

The antioxidant power of the compounds is evaluated by the DPPH method. 2,2-diphenyil-picrylhydrazyl (DPPH) is a stable radical for which the absorbance decreases at a characteristic wavelength when it is reduced by an antioxidant.

All the samples contain 200 μl.

The sample of 2,2-diphenyil-picrylhydrazyl (DPPH) is solubilised in ethanol at a concentration of 23 μg/ml

The samples of antioxidant molecules are solubilised in ethanol at a concentration of 80 μg/ml.

Once the DPPH is added to these samples, an absorbance measurement is carried out at 15, 30, 45, 90 and 120 minutes using a microplate spectrophotometer at 515 nm, corresponding to the absorbance maximum of the radical form of DPPH.

The calculation of the percentage inhibition for each molecule is the difference in absorbance of DPPH and the antioxidant molecule relative to DPPH. The inhibition percentages were averaged in order to have an average value as a function of time. The inhibition results for DPPH are shown in FIG. 18. A high inhibition percentage represents a higher percentage of reduced DPPH and therefore a stronger antioxidant capacity.

The water-soluble antioxidants tested are pomegranate extracts which comprise punicalagins and ellagic acid, grape extracts which include resveratrol and vitamin C. The liposoluble antioxidants tested are vitamin E, the essential oil of raspberry, turmeric and cinnamon.

As demonstrated in FIG. 18, the hydrophilic molecules tested are very effective as antioxidant. The most effective molecule is pomegranate (punicalagins and ellagic acid), followed by vitamin C, vitamin E and grape extract (resveratrol). Vitamin E with high antioxidant power is widely used for the protection of lipid compounds that are sensitive to oxidation. This is why it is found in Ω9, Ω6 and Ω3 polyunsaturated oils of vegetable or animal origin.

The antioxidant capacity of hydrophilic molecules is greater than or comparable to conventional hydrophobic antioxidants such as vitamin E.

These hydrophilic molecules have the advantage of being as effective as vitamin E, while being harmless, because the body easily removes the excess of these molecules in the urines.

### Example 2: Preparation of a Dispersion of Phyllosilicates, in Particular Bentonite, in Sunflower Oil

Dispersions of exfoliated bentonite particles are prepared with lecithin and water, following the principles described above, in sunflower oil at bentonite concentrations of 0.5 to 15 wt % relative to the weight of the lipid or oily phase, as indicated above. The lecithin content is 64 wt % and the water content 120 wt % relative to the weight of bentonite of the composition.

The size of the mineral particles obtained is measured as indicated above by dynamic light scattering, according to method 1.

FIG. 9 shows the result of measurements of particle size of bentonite dispersed in the lipid phase for two concentrations by mass of bentonite: 1% and 10%. At a concentration of 1%, the size distribution is monodispersed and has a maximum at 1 μm. At a concentration of 10%, a first particle peak is observed at 40 nm and a second at 900 nm.

Hence, the increase in concentration for a given shear energy leads to a reduction in particle size which results in an improvement in the dispersion.

FIG. 10 shows the change overtime in the size distribution of clay particles dispersed in a lipid phase with and without an additional dispersive treatment by ultrasound. The clay content in the lipid phase is 1 wt % relative to the weight of the lipid phase.

The additional treatment with ultrasound leads to the appearance of a size distribution peak at approximately 150 nm. Initially there is a size distribution peak at approximately 1 μm.

The additional treatment with ultrasound must therefore improve the dispersion of clay particles in the lipid phase with a very sensitive reduction in size of a considerable fraction of the particles.

### Example 3: Preparation of a Direct Emulsion

Direct emulsions were prepared using an oily phase/aqueous phase ratio of 40/60. The emulsification was carried out by addition of shear energy applied in batches, at ambient temperature, with a rotor/stator device having an air gap of 150 micrometres with a 30 mm spindle, at 4500 rpm for 4 minutes.

The average diameter of the lipid droplets of the dispersed phase of the direct emulsions was measured for all the concentrations of clay, using a particle size analyser as described in method 2. FIG. 11 (solid curve) shows the results obtained.

At low concentration, the quantity of bentonite is too low to stabilise these small droplets, so that they fuse creating large droplets, thus reducing the interface total surface area of the system to be stabilised. This limited coalescence process is typical of Pickering emulsions and is characterised by a strong increase in the diameter of the droplets at low concentrations.

At higher concentration, the droplet diameter ceases to decrease and stabilises at around 20 μm. In this range, the diameter of the droplets is stable although the quantity of bentonite increases. This can be attributed to the capacity of the sheets to orient cooperatively.

The bentonite sheets align inducing a densification of the clay layer at the interface of the droplets without variation in diameter.

The interfacial stabilisation properties of the clays were evaluated by a stability test consisting of centrifuging at 10,000 rpm for 5 minutes (FIG. 11, dotted curve). This test accelerated the natural creaming process due to different densities (the density of the oil is less than that of the water) and leads to a concentrated emulsion under tightly constrained conditions. Hence, the droplets are in contact, forcing coalescence when the interface is unstable or when the surface curvature is insufficient. The emulsions with the lowest concentration of clay are unstable, however this instability results from a lack of particles at the interface rather than an ineffective adsorption. The remainder of the emulsions are stable in the test.

Moreover, the size of the droplets was measured in order to check their mechanical resistance. No variation in the size and the size distribution was observed after centrifugation.

Hence, the emulsions have an excellent mechanical resistance to deformation and to coalescence. The dotted curve of FIG. 11 is practically identical to the solid curve, and hence the diameter of the droplets is the same before and after the centrifugation test at 10,000 rpm.

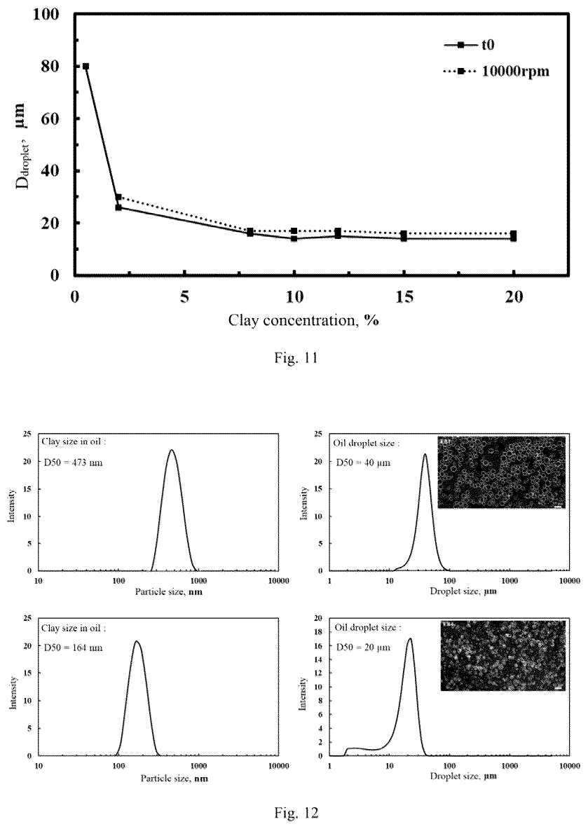

FIG. 12 illustrates the relation between the size of the bentonite particles dispersed in oil and the size of the oil droplets of the dispersed phase. For a bentonite particle size of 473 nanometres, assessed by the volume parameter D50, the size of the oil droplets is D50=40 μm.

The size ratio is 85. For a particle size of 164 nanometres, the droplet size is 20 μm. The size ratio is 122. This confirms that the finer the particle size, the smaller the size of the droplets of the dispersed phase. A ratio between 80 and 130 is observed. This figure also shows electron micrographs of the emulsions obtained.

### Example 4: Tests of the Oxidation Resistance of the Compositions According to the Invention

Several tests were carried out to show the interest of the preceding composition for reinforcing the resistance to oxidation of lipid compositions.

### Example 4a: Protocol for Exfoliation of Clay in Oil

An exfoliated clay composition was produced according to the following protocol.

First, vitamin C was mixed in distilled water using a spatula, until completely dissolved.

Then, lecithin was added and stirred vigorously until a homogeneous mixture was obtained (lecithin forms vesicles with the aqueous environment).

Then, the clay is added and mixed for 2×15 seconds in a bladed disperser at 3500 rpm.

The water and vitamin C become located between the clay sheets and swell it. The lecithin, in turn, becomes located at the surface of the sheets, which will, on the one hand, make the clays “hydrophobic” and therefore assist their dispersion in the oil and, on the other hand, by intercalation of the lecithin between the clay sheets, facilitate the exfoliation, i.e. the dispersion of the clays in the oil.

It is left to rest for 15 minutes (in order to optimise the swelling phase) then mixed again for 15 seconds.

Finally, sunflower oil is added, then it is mixed for 2×30 seconds in the bladed mixer (at 3500 rpm) in order to initiate the exfoliation of the clays in the oil. Then, the cod liver oil and vitamin E are added and mixed again for 2×30 seconds.

This pre-exfoliated system is then passed to the rotor/stator with an air gap of 150 micrometres and a 30 mm spindle at 4000 rpm for 3 minutes, in order to maximise the exfoliation of the clays in the oil. Compositions 4 and 5 are obtained.

In the tests described below, reference compositions 1, 2 and 3 without clay and without lecithin were produced according to the same protocol.

### Example 4b: Protocol for Preparing a Composition in the Form of an Oil-In-Water Emulsion

An emulsion was produced.

In a first step, the clay is exfoliated according to the protocol described in example 4a.

Then, the aqueous phase of the emulsion is prepared by diluting the salt in pure water.

The previously prepared clay exfoliation is added to the aqueous phase.

This mixture is then passed to the rotor/stator with an air gap of 150 μm and a 30 mm spindle at 5000 rpm for 5 minutes.

Composition 6 is obtained.

### Example 4c: Evaluation Test of the Oxidation Stability of Lipid Compositions

Table 1 shows the formulations of three reference oily compositions.

TABLE 1

| | Oil | Vit C | Vit E |
|---|---|---|---|
| 1 | 100 | 0 | 0 |
| 2 | 99.8 | 0 | 0.2 |
| 3 | 99.3 | 0.5 | 0.2 |

Table 2 shows the formulations of three compositions comprising clay. All the formulations are in percent by mass relative to the total mass of the sample. Compositions 4, 5 and 6 are structured, i.e. the clays have been swollen by water in which active molecules were dissolved, then exfoliated. Composition 6 is moreover a direct 40/60 oil-in-water emulsion and the components indicated for this sample correspond to the dispersed lipid phase.

TABLE 2

| | Clay | Lecithin | Water | Vit E | Vit C | Oil |
|---|---|---|---|---|---|---|
| 4 | 4 | 0.73 | 16 | 0.2 | 0 | 79.07 |
| 5 | 4 | 0.73 | 16 | 0.2 | 0.5 | 78.57 |
| 6 | 4 | 0.73 | 16 | 0.2 | 0.5 | 78.57 |

The samples were incubated under ambient atmospheric conditions, remaining protected from light, but at a temperature of 37° C. in order to accelerate the oxidation kinetics. Samplings were taken regularly for 7 weeks.

The peroxide values were assayed directly after the samplings by iodometry according to standard NF EN ISO 27107 and NF EN ISO 3960.

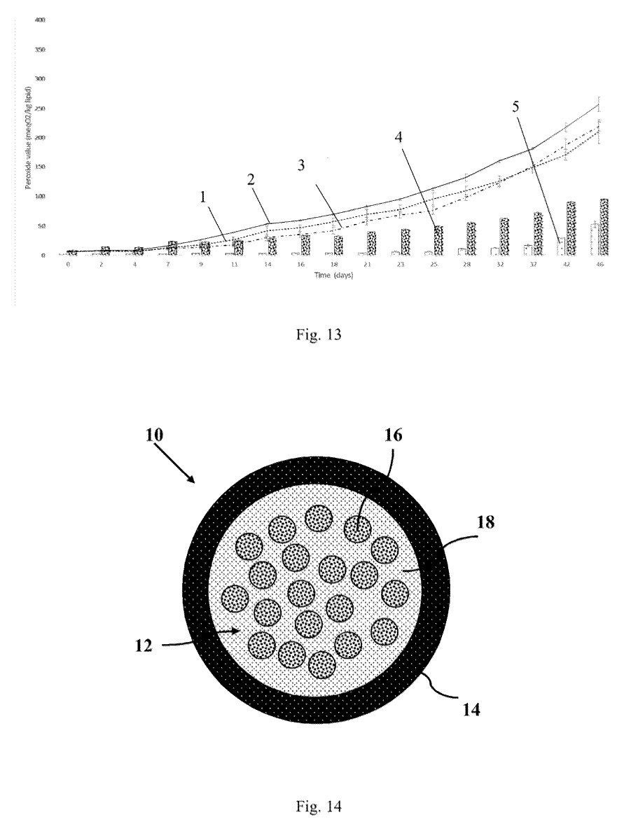

FIG. 13 shows the change over time of the oxidation kinetics (measurement of the peroxide values) for compositions 1 to 5. The X axis shows the number of days of sampling the samples, and the y-axis is the peroxide value measured in meqO2/kg of lipid phase. For ease of reading, the kinetics of the three reference compositions are presented in the form of curves and those of the two compositions 4 and 5 in the form of histograms.

FIG. 13 shows that, after a latency time of several days, the oxidation of the three reference compositions starts on the 7^{th} day, then increases more and more rapidly. The three references show similar oxidations, with a highest value for the reference comprising vitamin E only.

By contrast, the oxidations of the two samples comprising a supramolecular structure are very clearly less.

It can be concluded that the presence of particles of dispersed and exfoliated clay sheets in the composition limits the diffusion of reactive oxygen molecules by a barrier effect.

A very marked difference is noted between compositions 4 and 5, in particular during the first 30 days of the test. The presence of the hydrophilic antioxidant vitamin C, dispersed by adsorption on the particles of the supramolecular structure, provides a latency time of around 30 days before the development of notable oxidation of the composition.

The peroxide value of 15 is usually used as the limit not to be exceeded for human food products.

After around one week, this value is exceeded for the three reference compositions and for composition 4 only comprising vitamin E. By contrast, for composition 5 according to the invention comprising the molecular structure and vitamin C, this value is only reached after 32 days. This result illustrates the great interest of the supramolecular structure for serving as a vehicle for vitamin C, in order to protect lipid compositions from oxidation.

### Example 6: Evaluation of the Stability Against Oxidation of Lipid Compositions at High Temperature

Compositions 1 and 5, and emulsion 6 obtained according to examples 4b and 4c, were heated for 80 seconds at 120° C., then cooled slowly to 40° C. in 20 minutes. The compositions were analysed before and after heat treatment.

The peroxide values were assayed directly after the samplings by iodometry according to standard NF EN ISO 27107 and NF EN ISO 3960.

In this experiment, the secondary oxidation compounds, malondialdehyde (MDA), were also assayed, in order to confirm the observed peroxide value results and conclude that the lipids are well preserved from oxidation. Indeed, these MDA secondary compounds result from the breakdown of peroxides. A low peroxide value measurement could thus result from the formation of this secondary product and not from protection of the lipids from oxidation.

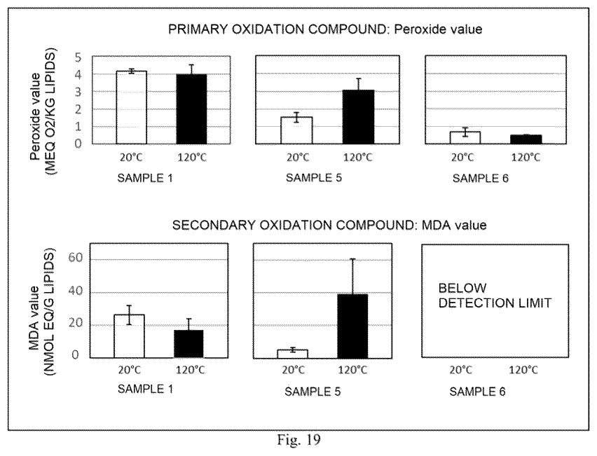

The results of two series of assays are presented in FIG. 19.

Composition 6, in the form of an emulsion according to the invention, considerably reduces the peroxide value compared with oil alone (composition 1). Composition 5 according to the invention, comprising the exfoliated clay, also effectively reduces the oxidation of lipids at high temperature. These structures effectively protect against oxidation by oxygen (process without heat) and thermal exposure (process with heat).

The MDA values confirm that the peroxides are not broken down into secondary oxidation compounds (MDA) for composition 6, confirming that the emulsion clearly better preserves the lipids from oxidation. For this composition 6, the MDA values are below the detection limit.

This complex assembly combines the performance of water-soluble antioxidants, physically absorbed in the phyllosilicates, with the surface area developed by the clay which will be dispersed in the oil by means of a surfactant such as lecithin or arginine This original assembly system offers a protection of lipids that has never previously been demonstrated, in particular during aggressive heat treatments known to rapidly breakdown the unsaturations of alkyl chains by oxidation or radical reaction.

1. A lipid composition comprising unsaturated lipids such as omega 3 and omega 6, antioxidants, an amphiphilic dispersant and phyllosilicate particles, wherein the phyllosilicate particles are clusters of sheets in which water is absorbed, and wherein the antioxidants comprise water-soluble antioxidants dissolved in the water adsorbed in the phyllosilicate sheets with a content greater than 0.01 wt % relative to the weight of the lipids of the composition, and wherein the phyllosilicate sheets are dispersed and exfoliated in the composition by the amphiphilic dispersant adsorbed on the surface of the phyllosilicate sheets.

2. The composition of claim 1, wherein the content of water-soluble antioxidant is between 0.125 wt % and 50 wt % relative to the weight of phyllosilicate particles, and preferably between 0.375 wt % and 35 wt % relative to the weight of phyllosilicate particles.

3. The composition according to claim 1, wherein the water-soluble antioxidant, is chosen from the group consisting of reducing salts, reducing enzymes, flavonoids, phenolic derivatives and water-soluble vitamins and combinations thereof, and preferably vitamin C.

4. The composition of claim 1, wherein the amphiphilic dispersant is chosen from the group consisting of ethyl lauroyl arginate (LAE), arginine-based cationic surfactants with 16 and more carbon atoms, phospholipids and combinations thereof.

5. The composition of claim 2, wherein the amphiphilic dispersant is a phosphoglyceride.

6. The composition of claim 3, wherein the amphiphilic dispersant is a phosphatidylcholine and preferably lecithin.

7. The composition of claim 1, wherein the lecithin sheets are smectite sheets and very preferably mostly montmorillonite sheets.

8. The composition of claim 1, wherein the dispersant content of the composition is between 10 wt % and 400 wt % and preferably between 20 wt % and 200 wt % relative to the weight of phyllosilicates.

9. The composition of claim 1, wherein the water content of the composition is between 10 wt % and 300 wt % and preferably between 20 wt % and 200 wt % relative to the weight of phyllosilicates.

10. An emulsion with an aqueous phase and a lipid phase, wherein the lipid phase is a lipid composition comprising unsaturated lipids such as omega 3 and omega 6, antioxidants, an amphiphilic dispersant and phyllosilicate particles, wherein the phyllosilicate particles are clusters of sheets in which water is absorbed, and wherein the antioxidants comprise water-soluble antioxidants dissolved in the water adsorbed in the phyllosilicate sheets with a content greater than 0.01 wt % relative to the weight of the lipids of the composition, and wherein the phyllosilicate sheets are dispersed and exfoliated in the composition by the amphiphilic dispersant adsorbed on the surface of the phyllosilicate sheets.

11. The emulsion of claim 10, wherein the emulsion is a direct emulsion and wherein the overall phyllosilicate content in the lipid phase is greater than 0.5 wt % relative to the weight of the lipid phase, and preferably between 1 wt % and 20 wt %.

12. The emulsion of claim 10, wherein the emulsion is an inverse emulsion, and wherein the overall phyllosilicate content in the lipid phase is less than 5 wt % relative to the weight of the lipid phase, and preferably between 0.005 wt % and 2 wt %.

13. A food, premix or food supplement (10, 20, 30) in the form of modular stackable objects enabling protection against oxidation and a controlled release of nutritive and/or physiologically active substances for monogastric species, with an aqueous phase (16, 26, 36) and a lipid phase (18, 28, 38) with liposoluble active components, wherein the aqueous phase and the lipid phase are an emulsion of claim 10.

14. The food, premix or food supplement (20) of claim 13, wherein the emulsion is a direct emulsion and wherein the droplets of the dispersed lipid phase (28) have a biopolymer coating (24), preferably chosen from the group consisting of chitosan, polylysine and hyaluronic acid.

15. The food, premix or food supplement (10, 30) of claim 13, comprising a core (12, 32) and a coating (14, 34) of the core (12, 32), wherein the core (12, 32) comprises the aqueous phase (16, 36) and said lipid phase (18, 38) and wherein the aqueous phase includes water-soluble active substances.

16. A method for manufacturing an extruded food, wherein the method comprises incorporating in or impregnating an extruded food with the composition of claim 1.

17. A method for stabilizing a lipid emulsion comprising dispersin and exfoliating phyllosilicates in a lipid phase.

18. The method of claim 17, comprising:
a) Preparing an aqueous solution of one or more water soluble antioxidants.
b) Adding the amphiphilic dispersant
c) Stirring to obtain a homogeneous mixture
d) Adding the clay and stirring the mixture obtained
e) Adding a lipid phase and applying a shear energy.
